(19) United States
(12) Patent Application Publication
(10) Pub. No.: US 2002/0196701 A1
(43) Pub. Date: Dec. 26, 2002

(54) Proportional liquid-mixing system

(76) Inventor: Clarence W. Mastbrook, Lomita, CA (US)

Correspondence Address: ROY A. EKSTRAND, STE 150, 3158 REDHILL AVE., COSTA MESA, CA, 92626, US

(21) Appl. No.: 10/183,204

(22) Filed: Jun. 25, 2002

Related U.S. Application Data
(60) Provisional application No. 60/300,945, filed on Jun. 26, 2001.

(51) Int. Cl. B01F 15/04

(52) U.S. Cl. 366/142; 366/162.1

(57) ABSTRACT

A proportional liquid-mixing system includes a first container having a float tube supported therein. The float tube is open at its upper and lower ends allowing the liquid levels in the float tube and the container to coincide. A float within the float tube supports an indicator which is visually observable by the user. A proportional reservoir is supported in proximity to the visual indicator and includes apparatus for accumulating a quantity of liquid for dispensing into the first container. The volume and cross-sectional area characteristics of the first container and proportional reservoir are selected to provide proportional volume verses depth characteristics in each liquid.

### CROSS-REFERENCE TO RELATED APPLICATIONS

This application discloses apparatus described in a provisional patent application serial No. 60/300,945 filed Jun. 26, 2001 and entitled PROPORTIONAL LIQUID MIXING SYSTEM HAVING AN EXCHANGEABLE PROPORTIONAL CONCENTRATE VESSEL AND ANTI-SPLASH DISPENSING which was filed by the Applicant of the present application.

### FIELD OF THE INVENTION

This invention relates generally to proportional mixing of liquids and particularly to apparatus used therein.

### BACKGROUND OF THE INVENTION

Proportional mixing of liquid chemicals is well known and common place in many industries throughout the art. Examples of proportional mixing are found in cleaning and maintenance systems such as floor care or the like, gardening or pest control, sanitation and the like. In addition, proportional mixing of liquid chemicals is also utilized in formulating the gasoline and lubricating oil mixture consumed by two cycle or two stroke internal combustion engines. While the foregoing examples are common place within various industries and pervasive throughout the art, additional virtually endless numbers of highly specialized proportional chemical mixing takes place throughout industry and commerce.

Each of the above referenced proportional mixing systems encounters problems and needs which are more or less specific to the host system. However, all proportional mixing systems share the common problem and challenge associated with the need for reliable, accurate and repeatable proportional volume mixing of liquids.

In certain industries, the primary concern in seeking accuracy of proportional liquid mixing is found in simple economics. That is to say, the avoidance of excessive use of expensive chemicals such as concentrates or detergents.

In other industries, greater concerns such as safety or effectiveness also arise. For example, cleaning and maintenance typically utilize concentrated detergents which are mixed proportionally with water for generally cleaning such as floor care. Most cleaning services employ simple mop and bucket apparatus for floor cleaning. Such apparatus is well known in the art and has been used for many years. While variations of apparatus exists, generally all utilize a quantity of water placed within a mop bucket within which a concentrated detergent solution is utilized. While this mixing of water and concentrate may be accomplished by simple hand measuring, pouring and mixing, most cleaning supply companies provided so-called “filling stations” near a convenient water supply such as a janitors closet within the host facility. Typically, the chemical supplier installs and maintains wall mounted apparatus for dispensing proportionate volumes of water and concentrate to be used by floor cleaning staff. The apparatus is usually based upon an eduction process directed toward proportionate mixing of concentrate and water which is deposited into the mop bucket. The use of one or more filling stations within suitable areas such as janitors closets or the like necessitates that the cleaning staff must return to a filling station each time the need arises to replenish or replace the cleaning solution within the mop bucket. In large areas such as shopping malls, office buildings or factories, this is often an inefficient and time wasting process. Since rentable space in facilities such as malls and office buildings must be maximized for economic gain, provision of ample “decentralized” janitor facilities is impracticable. As a result, cleaning efficiently and cost effectiveness is sacrificed in facility construction rather than reduce rentable income producing space.

Similar problems arises in food service industries and health care facilities such as, food stores or hospitals. In addition to cost and efficiency problems however, such facilities have additional concerns such as safety and sanitation.

Hospitals and food service facilities must clean and sanitize floors virtually constantly to meet health and food regulations. This means cleaning solution can not be “stretched” by cleaning staff attempting to cut corners and avoid replacing dirty or contaminated solutions as required. Effective sanitation requires more frequent cleaning and solution changes.

Attempts by practitioners in the art to avoid the use of centralized filling stations often leads practitioners to utilize so-called portable proportional filling systems. The basic concept is sound, that is to provide the cleaning staff for measuring and mixing proportionate concentrates at any convenient water source. The objective is to overcome the inefficiency of filling stations centralization. However, the use of such portable system creates more problems than it solves. Primarily, portable mixing systems lead to inaccurate proportioning of liquid components. Unskilled or unmotivated cleaning staff typically approximate ingredient quantities rather than carefully measure and mix. What is more problematic, such staff members tend to overuse concentrates—adding more than required for “good measure”. The overuse of cleaning concentrates is very costly to system operators. It is also potentially dangerous, in that, excessive detergent can result in floor surfaces which have a soap or detergent residue after drying. Such surfaces are not only improperly cleaned, but likely to be unusually slippery when wet due to the soap residue.

Many liquid mixing systems are also subject to further concerns beyond cost and efficiency which are related to environmental impact of the chemicals used. For example, pest control sprayer systems must be strictly and accurately controlled as to the amount of chemical dispersed in the spraying process. While a variety of chemical sprayers are available for pest control operations, the majority comprise hand carried tank-type sprayers having a reservoir filled with chemical mixture and the apparatus for pumping and pressurizing the tank. An elongated hose with a spray valve and nozzle is coupled to the tank allowing the operator to dispense the spray chemicals. In such systems, inaccurate proportioning of chemicals is simply unacceptable and is often illegal. Pest control operators for example must maintain accurate records of the amount of chemical sprayed at each location serviced. Obviously, without accurate proportional mixing of the chemicals such accurate records can not be maintained.

Another environmentally sensitive type of proportional mixing occurs in the formulation of fuel and lubricating oil mixture for use by two stroke or two cycle internal combustion engines. Such engines are favored by small tool designers and manufactures due to the substantial power produced for a given engine size. An important operating characteristic of two stroke or two cycle internal combustion engines is found in their use of a mixture of gasoline and lubricating oil rather than maintenance of separate fuel and lubricating apparatus. Thus, a quantity of lubricating oil is combined with the gasoline to form the fuel/oil mixture used in two stroke or two cycle internal combustion engines. As the engine runs, the circulation and consumption of the lubricating oil and fuel mixture provides lubrication to moving parts.

While two stroke or two cycle internal combustion engines are sometimes used for transportation purposes such as motorcycles or the like, there most pervasive use is found in small portable tools such as cutters, mowers and the like. Needless to say, the efficient operation and environmental needs surrounding the use of such engines requires accurate proportioning of the fuel and lubricating oil used therein. Unfortunately, accurate reliable and easy to use liquid mixing apparatus for uses such as two stroke engines has not been available.

Not surprisingly, the long felt and persistent need in the art for effective, efficient and accurate proportional liquid mixing systems has prompted practitioners in the art to develop a variety of systems. One of the most common types of proportional liquid mixing systems developed is represented in U.S. Pat. Nos. 5,522,419; 5,253,677 and 6,105,633 all of which employ an eduction or aspiration device to proportionately supply concentrate and base liquid such as water to a mixing vessel. Eduction or siphoning systems have enjoyed some popularity in the art. However, the systems tend to be expensive and must be installed by trained personnel. In addition, such system are subject to difficulties as the concentrate and mineral deposits from water tend to clog the precisely sized liquid passages. As a result, eduction or siphoning systems tend to require substantial maintenance. In addition, accuracy is often compromised due to variations of water temperature and concentrate viscosity as well as other perimeters such as pressure at the operative location.

Additional systems intended to supply so-called portable operation include manual measuring cups for measuring the proportionate liquids to be combined. However, this is not truly proportional and is often misused or compromised by less than skilled personnel. Practitioners have also attempted to utilize packets in which a group of packets of a given premeasured size is supplied to be combined in the mixture process. Of necessity, such packets are more expensive than bulk liquid and often resort to powered constituents to facilitate use. Powered components often provide a safety problem.

While the foregoing described prior art apparatus and systems have to some extent improved the art and in some instance enjoyed commercial success, there remains nonetheless a continuing need in the art for an evermore improved proportional liquid mixing system which overcomes the discrepancies, shortcomings and problems of the prior art systems.

### SUMMARY OF THE INVENTION

Accordingly, it is a general object of the present invention to provide an improved proportional liquid mixing system. It is more particular object of the present invention to provide an improved proportional liquid mixing system which avoids the need for centralized filling station operation and may be operated at any convenient water or chemical supply location. It is still further object of the present invention to provide an improved proportional liquid mixing system which utilizes a minimum of operator skill and motivation and which maintains accurate proportional component quantities regardless of the quantity of mixture to be made at any given time.

In accordance with the present invention there is provided a proportional liquid-mixing system comprising: a first liquid container receiving a first volume of first liquid and establishing a first liquid level therein; a second liquid container receiving a second volume of a second liquid, the second liquid container defining a cross-sectional area which is related to a predetermined mixing ratio between the first and second liquids; a level indicator responsive to the first liquid level for indicating the level of the second liquid within the second liquid container to establish a second volume related to the first volume of the first liquid in accordance with the mixing ration; and means for combining the first and second volumes.

In another respect, the present invention provides a proportional liquid-mixing system comprising: a first liquid container having a first liquid volume defining a first liquid level; a second liquid container for receiving a second liquid volume to define a second liquid level; liquid level indication means having a level indicator proximate the second liquid container positioning the level indicator in response to the first liquid level; means for filing the second liquid container with the second liquid to establish a second liquid level generally aligned with the position of the level indicator; and means for transferring the second liquid to the first container.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a partially sectioned side elevation view of a proportional liquid-mixing system constructed in accordance with the present invention;

FIG. 2 sets forth a partially sectioned rear view of the proportional liquid-mixing system set forth in FIG. 1;

FIG. 3 sets forth a simplified partially sectioned perspective view of the basic operative elements of the present invention proportional liquid-mixing system;

FIG. 4 sets forth a partially sectioned front view of an alternate embodiment of the present invention proportional liquid-mixing system;

FIG. 5 sets forth a partially sectioned side elevation view of the alternate embodiment of FIG. 4;

FIG. 6 sets forth a partially sectioned front view of a further alternate embodiment of the present invention proportional liquid-mixing system having a wall mount apparatus;

FIG. 7 sets forth a partially sectioned side elevation view of a still further alternate embodiment of the present invention proportional liquid-mixing system showing a pressurizable pump sprayer;

FIG. 8 sets forth a partially sectioned front view of the embodiment of FIG. 7;

FIG. 9 sets forth a partially sectioned side elevation view of a still further alternate embodiment of the present invention proportional liquid-mixing system showing a gasoline and oil mixing device.

### DESCRIPTION OF THE PREFERRED EMBODIMENTS

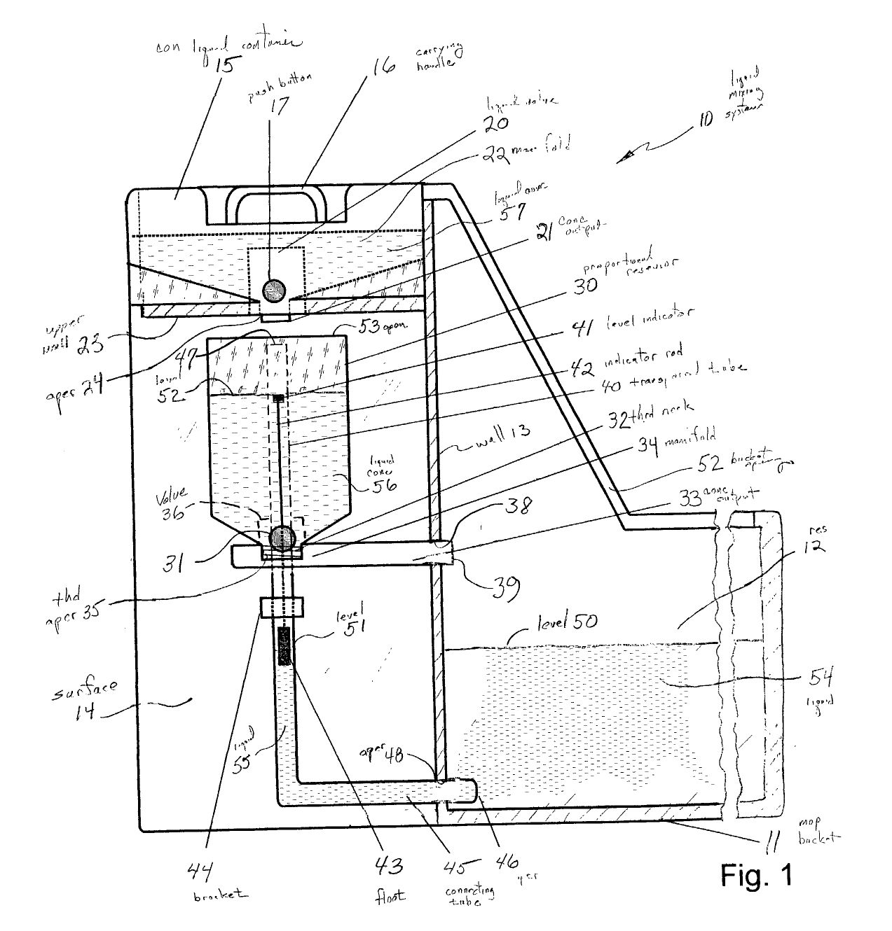

FIG. 1 sets forth a partially sectioned side elevation view of a proportional liquid-mixing system constructed in accordance with the present invention and generally referenced by numeral 10. System 10 comprises a mop bucket embodiment of the present invention having a mop bucket 11 defining an interior reservoir 12 and an upwardly facing bucket opening 52. System 10 supports a quantity of liquid 54 which, in accordance with the anticipated use of system 10, comprises a quantity of water within reservoir 12 establishing a water level 50 therein.

System 10 further supports a wall 13 completing the closure of reservoir 12 and a surface 14. Surface 14 supports an upper wall 23 having an aperture 24 defined therein. A generally right angle connecting tube 45 defines an aperture 46 within reservoir 12 and extends through an aperture 48 formed in wall 13. The remaining portion of connecting tube 45 extends vertically to a support bracket 44 secured to surface 14 of liquid-mixing system 10. Aperture 46 allows a portion of liquid 54 to flow through connecting tube 45 and establishes a water level 51. Connecting tube 45 extends vertically to an open end 47 above water level 50. The upper portion of connecting tube 45 includes a transparent tube 40 extending downwardly from open end 47. While open upper end 47 may be completely open, it is advantageous to provide a small vent aperture instead of a full open end. This prevents float 43, rod 42 and indicator 41 from falling out of tube 40 should the device be inverted.

In further accordance with the present invention, a manifold 34 extends through an aperture 38 formed in wall 13 and is secured to surface 14 by conventional attachment means (not shown). Manifold 34 defines an open end 39 extending into reservoir 12 and a threaded aperture 35.

A proportional liquid reservoir 30 formed of a transparent material defines an open upper end 53 and a threaded neck 32 at its lower end. Threaded neck 32 is received within threaded aperture 35. In the preferred fabrication of the present invention, threaded neck 32 and threaded aperture 35 form cooperating “half turn” threaded engagement. However, it will be apparent to those skilled in the art that a variety of attachment apparatus operative between neck 32 and manifold 34 may be utilized without departing from the spirit and scope of the present invention. For example, threaded neck 32 and threaded aperture 35 may utilize conventional threaded engagement apparatus. By way of further example, a press fit or force fit insertion may be utilized for securing the lower end of proportional reservoir 30 and manifold 34 without departing from the spirit and scope of the present invention. In such case, an appropriate seal such as a conventional O-ring or the like may be utilized.

Proportional reservoir 30 supports a quantity of liquid concentrate 56 establish to a level 52 within reservoir 30. Reservoir 30 further includes a conventional push button valve 36 having a push button 31 for actuation thereof. The actuation of valve 36 achieved by pushing push button 31 allows the liquid within proportional reservoir 30 to flow into manifold 34 and outwardly from aperture 39 into liquid 54.

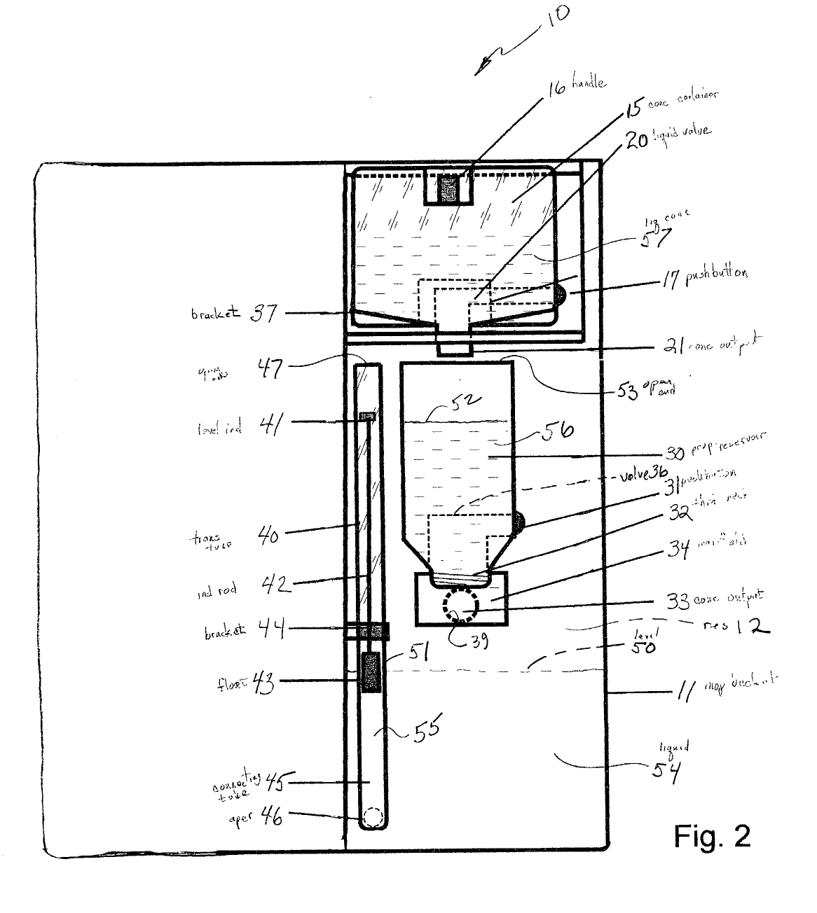

In further accordance with the present invention, a float 43 is received within the vertical portion of connecting tube 45 and further supports an upwardly extending preferably rigid indicator rod 42. Rod 42 further supports a level indicator 41. Float 43 is supported by liquid 55 within connecting tube 45. Indicator rod 42 supports level indicator 41 within the upper portion of transparent tube 40. Accordingly, level indicator 41 is visible and, as is better seen in FIG. 2, is positioned proximate proportional reservoir 30.

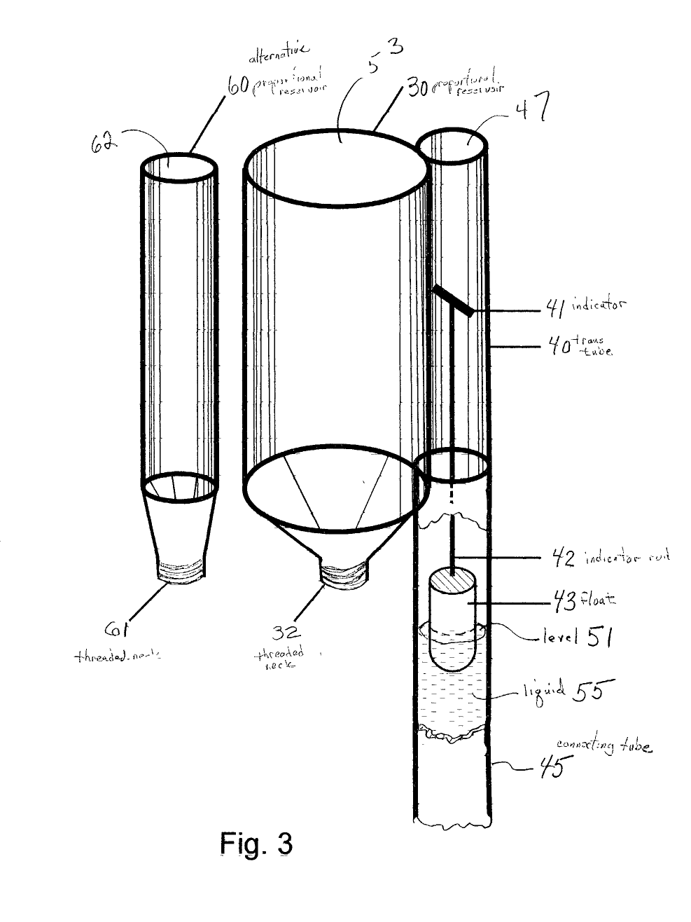

Liquid-mixing system 10 further includes a concentrated liquid container 15. Container 15 is supported upon upper wall 23 and is removably secured to the remainder of liquid-mixing system 10. Liquid container 15 includes a carrying handle 16 and a manifold 22 which in turn receives and supports a quantity of liquid concentrate 57. Liquid container 15 further includes a push button valve 20 having a push button 17. Valve 20 further includes a concentrated liquid output 21 extending downwardly through an aperture 24 formed in wall 23. It will be understood that output 21 is positioned above open end 53 of proportional reservoir 30. Thus, actuation of valve 20 by pressing push button 17 allows a portion of liquid concentrate 57 to flow downwardly through output 21 into the interior of proportional reservoir 30. In the preferred fabrication of the present invention, concentrated liquid container 15 is removably supported upon liquid-mixing system 10 to allow replacement or interchange of liquid concentrate. Similarly, and in further accordance with the preferred fabrication of the present invention, proportional reservoir 30 may be interchangeably replaced by a differently sized reservoir in the manner shown in FIG. 3 for variation of the mixing proportion described below. Suffice it to note here that the quantity of liquid comprising a liquid level within proportional reservoir 30 is directly related to the cross-sectional area of reservoir 30. Accordingly, interchange of proportional reservoir 30 with differently sized proportional reservoir such as proportional reservoir 60 shown in FIG. 3 results in a different liquid volume for a given liquid level within the proportional reservoir.

In operation, a quantity of liquid such as water is deposited within reservoir 12 of mop bucket 11 to establish a quantity of liquid 54 defining an liquid level 50. In accordance with an important aspect of the present invention, and as is set forth below in greater detail, the operation of system 10 does not require the measurement of a specified quantity of water or other liquid within reservoir 12 to obtain proportional mixing of the concentrated liquid within proportional reservoir 30. Thus, with liquid 54 deposited within reservoir 12 establishing a liquid level 50, a corresponding and equal level 51 is established within liquid 55 of connecting tube 45. As a result, float 43 is supported by liquid 55 at a predetermined position with respect to level 51. With the length of indicator rod 42 and thereby the positional relationship between indicator 41 and float 43 having been pre-established, the flotation of float 43 within liquid 55 positions level indicator 41 at a predetermined position which is determined by level 50 of level 54.

Once liquid 54 has been deposited within reservoir 12, the user activates push button 17 of liquid valve 20 to discharge liquid concentrate 57 downwardly from liquid container 15 through output 21. The downwardly flowing liquid concentrate passes through opening 53 and is received within the interior of proportional reservoir 30. In the preferred utilization of the present invention, the operator is simply required to manipulate push button 17 until liquid concentrate 56 within proportional reservoir 30 is filled to level 52 in alignment with level indicator 41. It will be noted that in the event reservoir 12 had been filled to raise level 50 of liquid 54, level 51 would be correspondingly increased raising level indicator 41 and increasing the amount of liquid concentrate 56 required to align level 52 with indicator 41. Conversely, in the event a reduced quantity of liquid 54 is placed within reservoir 12, levels 50 and 51 would be correspondingly lower which in turn would correspondingly lower level indicator 41 allowing the operator to fill proportional reservoir 30 with a reduced amount of liquid concentrate aligning level 52 with the reduced height of level indicator 41.

In accordance with an important aspect of the present invention, the cross-sectional area of proportional reservoir 30 is selected in accordance with the desired volume of liquid to be mixed with liquid 54. Once the size of proportional reservoir 30 has been selected, each volume of liquid 54 within mop bucket 11 produces a corresponding position of level indicator 41. With level indicator 41 positioned, the required level of liquid concentrate 56 to be placed within proportional reservoir 30 is achieved by simply aligning level 52 with level indicator 41.

Thus, the operation of system 10 becomes exceedingly simple for the operator and requires no measurement or calculation by the operator in any manner. Simply stated, the user fills reservoir 12 with the desired quantity of water or other liquid and thereafter observes the position of level indicator 41. Next, the operator simply transfers a sufficient quantity of concentrated liquid 57 from container 15 using push button 17 into proportional reservoir 30 until level 52 is aligned with level indicator 41. Thereafter, the user transfers the quantity of liquid concentrate within proportional reservoir 30 into reservoir 12 using push button 31 allowing liquid concentrate 56 within proportional reservoir 30 to flow through manifold 34 and opening 39 into reservoir 12. This entire process is carried forward in a portable manner using virtually any source of water for liquid 54. No proportional liquid-mixing apparatus or centralized filling station such as those used in the above described prior art is required. It will be apparent to those skilled in the art that the proportional mixing carried forward by the present invention system is extremely accurate and easy for even the most unskilled of operators to use.

When the operator desires to change the liquid mixture within mop bucket 11, the operator simply empties reservoir 12 in a convenient sink or other facility and thereafter refills reservoir 12 and using the above described measurement transfers the desired quantity of concentrate from container 15 into proportional reservoir 30 which in turn is then transferred into reservoir 12 completing the replenishing of liquid mixture within mop bucket 11.

FIG. 2 sets forth a partially sectioned rear view of liquid-mixing system 10 shown in FIG. 1. As described above, liquid-mixing system 10i includes a mop bucket 11 within which a quantity of liquid such as water 54 establishes a liquid level 50. As is also described above, a bracket 44 supports a connecting tube 45 having an aperture 46 continuous with reservoir 12 of mop bucket 11. Connecting tube 45 further includes a transparent tube 40 having an open end 47 extending upward from bracket 44. A float 43 is supported by liquid 55 within connecting tube 45 and further supports an upwardly extending indicator rod 42 having a level indicator 41 at the upper end thereof.

A proportional reservoir 30 having a predetermined cross-sectional area defines an open upper end 53 and a threaded neck 32 at its lower end. Proportional reservoir 30 further includes a push button valve 36 having a push button 31 for actuation thereof.

A manifold 34 is supported by conventional support means (not shown) and defines a concentrated liquid output 33 terminating in an aperture 39 within reservoir 12 as is best seen in FIG. 1.

System 10 further includes a concentrated liquid container 15 supported by mop bucket 11 and having a carrying handle 16. Concentrated liquid container 15 further includes a liquid valve 20 operated by a push button 17 and having a downwardly extending concentrated liquid output 21. Output 21 is positioned above open end 53 of reservoir 30. A bracket 37 supports concentrated liquid container 15 in a convenient fashion allowing container 15 to be removed and replaced as required.

FIG. 3 sets forth a simplified partial perspective view of the liquid proportioning system of the present invention. For purposes of illustration, connecting tube 45 is shown extending upwardly and terminating in a transparent tube 40. Transparent tube 40 defines an open upper end 47. Accordingly, a quantity of liquid 55 establishes a liquid level 51 within the interior of connecting tube 45. As described above, level 51 corresponds to level 50 of liquid 54 within reservoir 12 of mop bucket 11 (seen in FIG. 1). The use of open end 47 for transparent tube 40 ensures that level 51 maintains this correspondence. As the liquid level within reservoir 12 (seen in FIG. 1) is raised or lowered, level 51 is raised or lower in direct correspondence. A float 43 is supported by liquid 55 within connecting tube 45 and due to its buoyancy, moves directly with level 51 as the level changes. An indicator rod 42 extends upwardly from float 43 and supports a visual level indicator 41 which, due to the transparency of tube 40, is visible by the operator.

A proportional reservoir 30 defines an open end 53 and a threaded neck 32 at the lower end thereof. As is set forth above in FIGS. 1 and 2, and in accordance with the present invention, proportional reservoir 30 is supported at a predetermined relationship with connecting tube 45 and transparent tube 40. In further accordance with the present invention, the cross-sectional area of proportional reservoir 30 is selected in accordance with the desired liquid proportion to be maintained between the concentrated liquid within reservoir 30 and liquid 54 within reservoir 12 (seen in FIG. 1). Because the liquid level within the mop bucket directly corresponds to level 51 of liquid 55 within connecting tube 45 and because the volume at any liquid level within reservoir 12 and proportional reservoir 30 is linearly related to the height of the liquid volume, the concentrated liquid required to fill reservoir 30 to indicator 41 for any level of liquid within reservoir 12 (seen in FIG. 1) maintains the desired proportional volume relationship for proportional mixing.

In the event the proportional relationship between the concentrated liquid and liquid 54 (seen in FIG. 1) requires changing, an alternative proportional reservoir such as reservoir 60 may be substituted for proportional reservoir 30. By way of example, alternative proportional reservoir 60 is shown having a substantially smaller cross-sectional area than reservoir 30. This means that when proportional reservoir 30 is removed and replaced by proportional reservoir 60 using threaded neck 61, a substantial altered mixing proportion is established. It will be apparent to comparison of proportional reservoir 30 and 60 that the volume of fluid required to establish a liquid concentrate level corresponding to any level of indicator 41 is substantially less for reservoir 60 than for reservoir 30. In other words, the use of reservoir 60 in place of reservoir 30 produces a substantially reduced proportion of concentrate to liquid 54 within reservoir 12 (seen in FIG. 1).

It will be apparent to those skilled in the art for purposes of convenience, reservoir 30 and 60 are shown cylindrical in shape. However, it will be equally apparent to those skilled in the art that the use of cylindrical reservoir is convenient but does not form a limitation of the present invention. On the contrary, it will be apparent that virtually any cross-sectional shape for reservoir 30 and 60 may be utilized without departing from the spirit and scope of the present invention. For example, reservoir 30 and 60 may define square, rectangular, triangular, octagonal, hexagonal or virtually any cross-sectional shape without departing from the spirit and scope of the present invention.

It will be apparent to those skilled in the art that the present invention system may be formed as an integral system within an dedicated mop bucket as an effective manner of practicing the present invention. However, it will be equally apparent from the material set forth below that the present invention proportional liquid-mixing system may be utilized as a non-integrated system to be employed in combination with an otherwise conventional mop bucket. For example, the present invention system may be utilized as an add on system supported for example by a conventional mop ringer or the like. Such mop ringers often fit within large mop buckets or alternatively have large support portions which receive a smaller bucket. In either event it will be understood that the present invention system is not limited to the fabrication as an integrated element within a mop bucket but rather is capable of further use in virtually any proportional liquid-mixing environment.

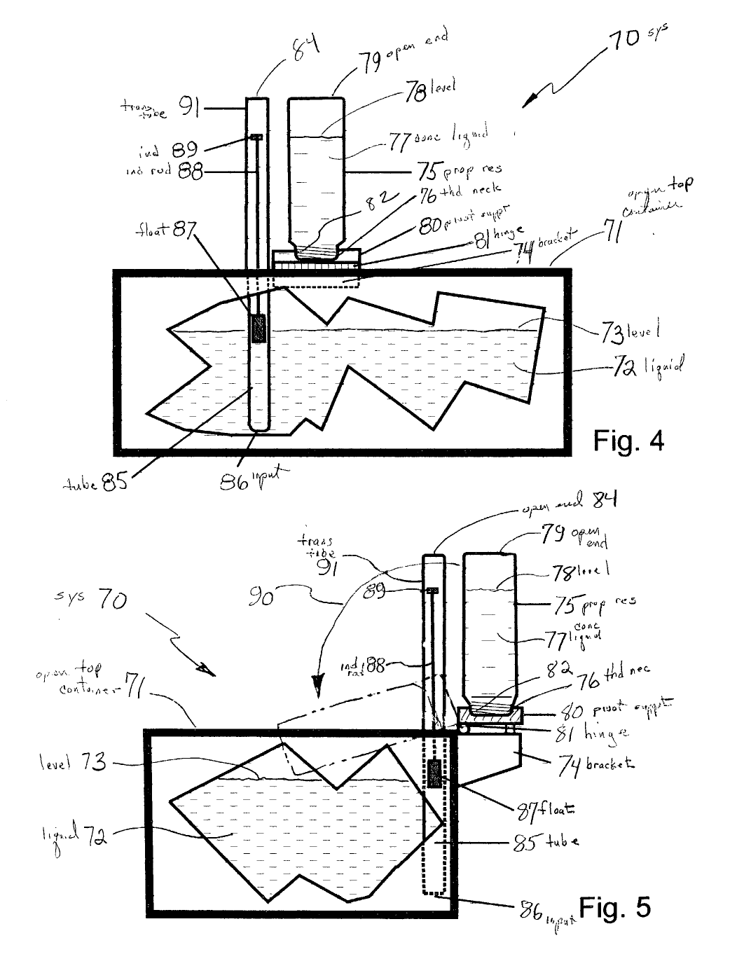

FIGS. 4 and 5 set forth respective front and side elevation views in partial section of an alternate embodiment of the present invention proportional liquid-mixing system generally referenced by numeral 70. System 70 will be understood to provide a generalized proportional liquid-mixing system which, in accordance with the present invention may be used to mix proportional volumes of two different liquids to form a desired mixture. For example, system 70 may be utilized to mix a liquid concentrate with a liquid such as water. Alternatively, system 70 may be utilized to mix two different liquids in a desired proportion.

More specifically, system 70 includes an open top container 71 supporting a volume of liquid 72 establishing a liquid level 73. System 70 further includes a bracket 74 secured to one portion of open top container 71. Bracket 74 includes a hinge 81 joined to bracket 74 and a pivoting support 80. Support 80 defines a threaded recess 82. A proportional reservoir 75 defines an open upper end 79 and a threaded neck 76. Neck 76 threadably engages recess 82 to provide a liquid tight attachment between pivoting support 80 and proportional recess 75.

System 70 further includes a tube 85 supported within open top container 71 and having an open input 86 at the bottom end thereof. Tube 85 further defines an open upper end 84. In accordance with an important aspect of the present invention, tube 85 defines a transparent upper tube 91. A float 87 is positioned within tube 85 and further supports an upwardly extending indicator rod 88 which in turn supports a visual indicator 89. Float 87 is supported within tube 85 by the liquid therein.

In operation, a quantity of liquid 72 within container 71 establishes a liquid level 73. Because tube 85 is open at input 86 and upper end 84, the liquid level within tube 85 corresponds directly to level 73 of liquid 72. Accordingly, float 87 is supported at level 73 by the flotation thereof within tube 85. Because float 87, rod 88 and indicator 89 are securely joined, the position of indicator 89 is a direct function of the height of liquid level 73.

In accordance with the present invention, the cross-sectional area selected for proportional liquid reservoir 75 corresponds to the desired volume ratio or proportionality to be maintained between a liquid concentrate and liquid 72 within open container top 71. Accordingly, the user having placed liquid 72 within container top 71, is able to provide a corresponding proportional volume of concentrated liquid 77 by simply filling proportional reservoir 75 through open end 79 until level 78 of liquid 77 is aligned with indicator 89. At this point, regardless of the volume initially deposited for liquid 72, the appropriate proportional volume of liquid concentrate 77 is accurate so long as the user aligns level 78 with indicator 89. No measurement of either volume of liquid is required.

FIG. 5 sets forth a side elevation view of system 70 having a quantity of liquid concentrate 77 within the proportional reservoir appropriate to the desired mixture.

More specifically, system 70 includes an open top container 71 supporting a volume of liquid 72 establishing a liquid level 73. System 70 further includes a bracket 74 secured to one portion of open top container 71. Bracket 74 includes a hinge 81 joined to bracket 74 and a pivoting support 80. Support 80 defines a threaded recess 82. A proportional reservoir 75 defines an open upper end 79 and a threaded neck 76. Neck 76 threadably engages recess 82 to provide a liquid tight attachment between pivoting support 80 and proportional recess 75.

System 70 further includes a tube 85 supported within open top container 71 and having an open input 86 at the bottom end thereof. Tube 85 further defines an open upper end 84. In accordance with an important aspect of the present invention, tube 85 defines a transparent upper tube 91. A float 87 is positioned within tube 85 and further supports an upwardly extending indicator rod 88 which in turn supports a visual indicator 89. Float 87 is supported within tube 85 by the liquid therein.

In operation, the user having filled proportional reservoir 75 with liquid concentrate 77 to align level 78 with indicator 89 transfers the appropriate volume of liquid concentrate by simply pivoting proportional reservoir 75 and pivots support 80 about hinge 81 in the manner indicated by arrow 90. The transfer position for system 70 is shown in phantom line depiction as the previously determined quantity of liquid concentrate 77 is caused to flow from proportional reservoir 75 into open top container 71. Thereafter, proportional reservoir 75 is then pivoted upwardly and returned to the position shown in solid line.

Thus, in the generalized system shown as system 70 in FIGS. 4 and 5, the user is able to easily and accurately combine any two liquid elements in a consistent proportion regardless of the quantity of liquid 72 initially placed within container 71. The use of tube 85 and float 87 together with indicator rod 88 and indicator 89 automatically establishes the correct level of the second liquid to be added. As described above, it will be apparent to those skilled in the art that the cross-sectional area of proportional reservoir 75 is selected in accordance with the desired proportion or ratio of liquids to be mixed within open top container 71. That is to say, that a smaller cross-sectional area proportional reservoir in place of reservoir 75 would increase the ratio of liquid 72 to concentrated liquid 77. Conversely, an increased cross-sectional area for proportional reservoir 75 would decrease the ratio of liquid 72 to concentrated liquid 77. Thus, it will be apparent that in the generalized system shown in FIGS. 4 and 5, different proportional reservoir containers may be threadably secured to pivot support 80 to obtain different liquid proportional volumes.

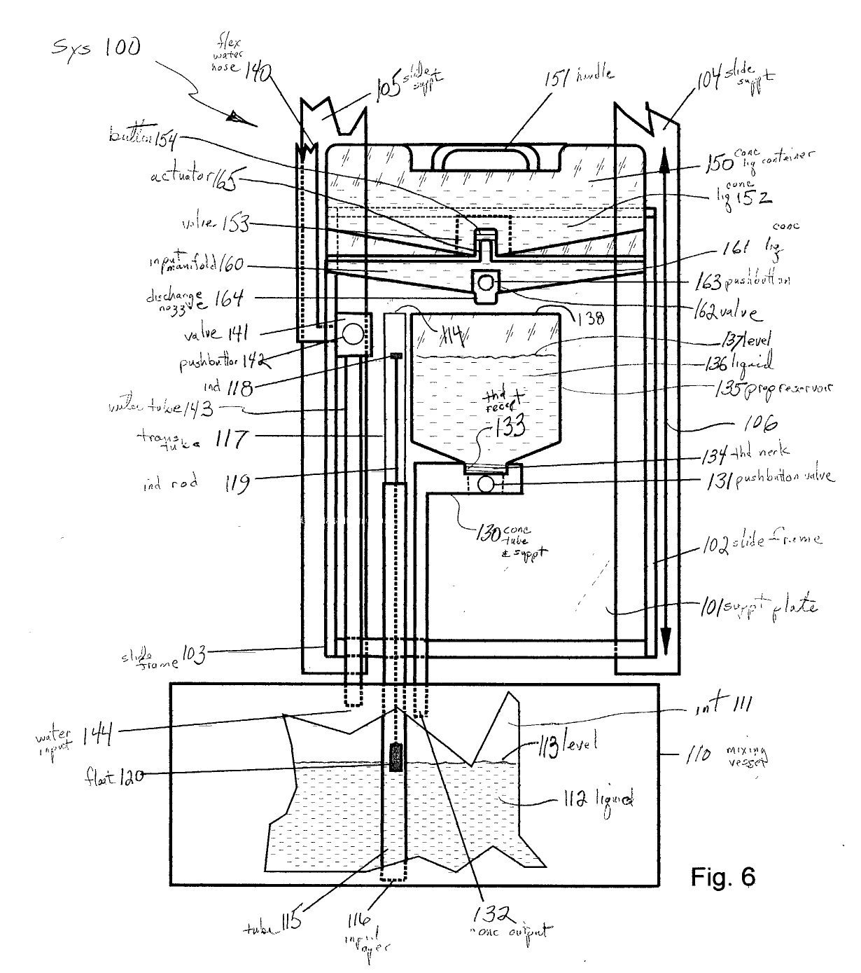

FIG. 6 sets forth a partially sectioned front view of a still further alternate embodiment of the present invention proportional liquid-mixing system generally referenced by numeral 100. While system 100 functions in substantially the same manner as system 10 described above in FIGS. 1 though 3, the structure of system of 100 is fabricated to facilitate a wall mounted system. Accordingly, system 100 includes a pair of slide supports 104 and 105 secured by conventional fastening means (not shown) to a support wall. A pair of slide frames 102 and 103 slidably engage slide supports 104 and 105 in a conventional sliding attachment which allows slide frames 102 and 103 to be moved vertically up or down in the directions indicated by arrows 106. A generally planar support plate 101 is secured to an carried between slide frames 102 and 103.

A valve 141 having a push button actuator 142 is secured to support plate 101. A water tube 143 extends downwardly from valve 141 and terminates in an open end 144. A flexible water hose 140 is coupled to valve 141 and is further joined to a source of water (not shown).

A concentrated liquid tube and reservoir support 130 is secured to support plate 101 by conventional fastening means (not shown). Tube 130 defines an open end 132 and a threaded receptacle 133. A proportional reservoir 135 defines a threaded neck 134 which is received within receptacle 133. Proportional reservoir 135 further includes an open upper end 138. A push button valve 131 is supported within tube 130 and is operative to open or close the liquid flow through threaded neck 134.

A concentrated liquid container 150 includes a support handle 151 and a quantity of liquid concentrate 152. Container 150 further includes a valve 153 having a button 154. System 100 further includes an input manifold 160 supported beneath container 150 and above proportional reservoir 135. Manifold 160 includes an actuator 165 extending upwardly against push button 154 of valve 153. Manifold 160 further includes a push button valve 162 having a push button 163 and a discharge nozzle 164. Nozzle 164 is positioned above open end 138 of proportional reservoir 135.

System 100 further includes a tube 115 having an open lower end 116 and an open upper end 114. Tube 115 further includes a transparent tube 117 on the upper portion thereof. A float 120 is supported within tube 115 and further supports an upwardly extending indicator rod 119 which in turn supports an indicator 118.

In operation, an open top mixing vessel 110 is positioned beneath system 100 after which system 100 is lowered upon slide supports 104 and 105 to extend open end 116 of tube 115 downwardly into vessel 110. The preferred vertical position of system 100 provides a close positioning between open end 116 of tube 115 and the bottom surface of mixing vessel 110. This positioning also moves lower end 144 of water tube 143 and open end 132 of tube 130 into mixing vessel 110.

Once mixing vessel and system 100 are properly positioned, the user actuates push button 142 of valve 141 to transfer a desired quantity of water 112 into the interior of mixing vessel 110. The quantity of liquid transferred establishes a water level 113. The open ends of tube 115 ensure that the water level within tube 115 corresponds to level 113 of liquid 112. Accordingly, float 120 is supported within tube 115, an indicator 118 is positioned along side proportional reservoir 135 at a position which is a function of level 113.

The positioning of container 150 upon manifold 160 causes actuator 165 to press button 154 of valve 153. As valve 153 opens, a quantity of liquid 152 flows downwardly into manifold 160. Once manifold 160 has filled, the liquid flow stops and the remaining quantity of liquid 152 remains within liquid container 150. The interlock feature provided by valve 153 and actuator 165 allows liquid container 150 to be removed from system 100 if desired.

Once the desired quantity of water has been received within mixing vessel 110 as indicated by liquid 112 having water level 113, the user then is able to transfer the proportionate volume of liquid concentrate to proportional reservoir 135 by pressing push button 163 of valve 162. The position of indicator 118 provides the user with the appropriate level for liquid 136 transferred to reservoir 135. Once level 137 of liquid 136 coincides with indicator 118, the user releases push button 163 closing valve 162.

At this point, the desired proportionate volume of liquid 136 is now transferred to proportionate reservoir 135. The user thereafter simply opens push button valve 131 to transfer liquid 136 downwardly through tube 130 and open end 132 into liquid 112. At this point, the mixture of liquid 112 is proportionately correct and system 100 is raised to withdraw tube 115 from mixing vessel 110.

Once again, it will be noted that the present invention system provides the user with an automatic indication of the level to which the proportional reservoir is to be filled for each quantity of the base liquid to be mixed. The cross-sectional area of the proportioning reservoir ensures the appropriate proportion or ratio of liquids for any given volume of the base liquid (liquid 112).

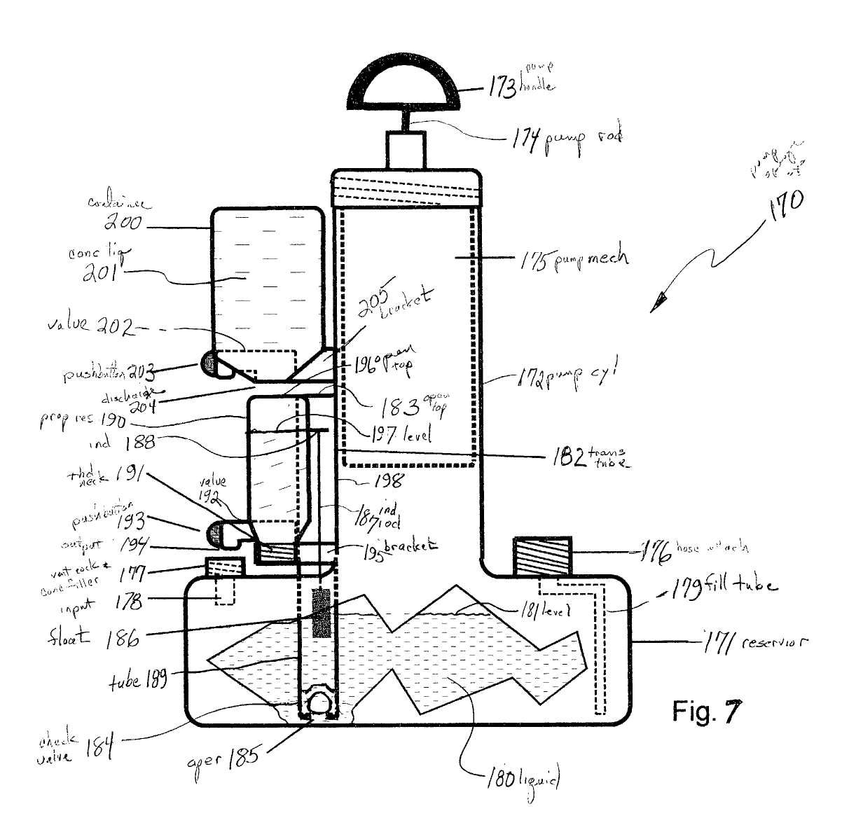

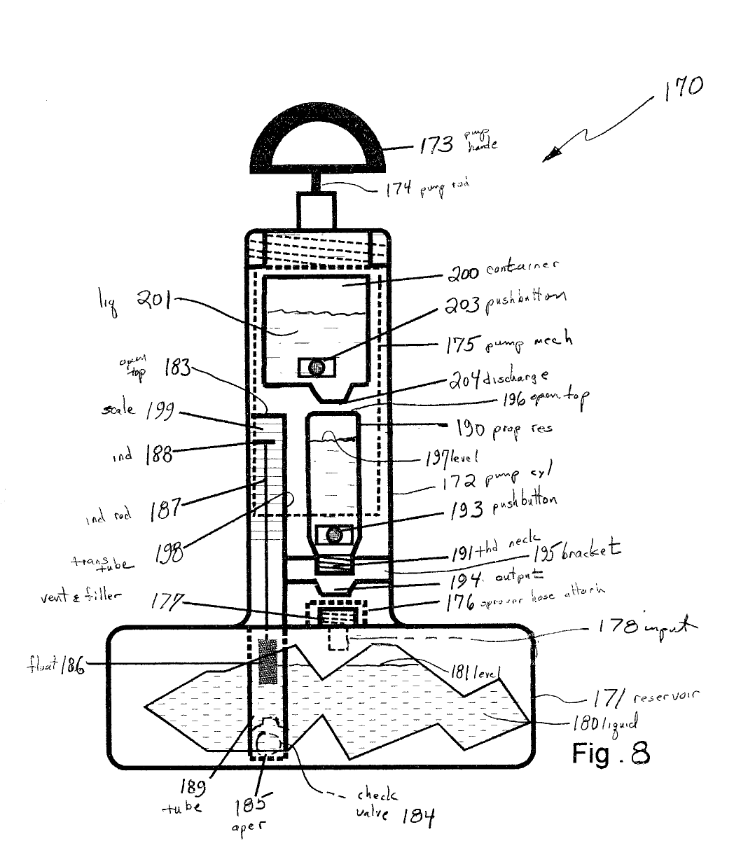

FIGS. 7 and 8 set forth partially sectioned side and front views respectively of a still further alternate embodiment of the present invention generally referenced by numeral 170. The embodiment shown in FIGS. 7 and 8 provides a pump sprayer apparatus which includes the present invention proportional liquid-mixing system.

More specifically, pump sprayer system 170 includes a reservoir 171 and an upwardly extending pump cylinder 172. A pump pressurizing mechanism 175 constructed in accordance with conventional fabrication techniques is secured within pump cylinder 172. A pump rod 174 is received within pump mechanism 175 and extends upwardly to a pump handle 173. Pump reservoir 171 further supports a hose attachment 176 which in turn is coupled to a fill tube 179 extending downwardly into reservoir 171. Hose attachment 176 is configured to receive a conventional sprayer hose and sprayer nozzle apparatus (not shown). Reservoir 171 further supports a vent valve and liquid filler 177. Valve 177 supports a downwardly extending tube 178.

A bracket 195 extends outwardly from pump cylinder 172 and further includes a valve 192 having a push button actuator 193 and an output 194. Output 194 is aligned with vent and filler 177. A tube 189 is formed within reservoir 171 and extends upwardly to a transparent tube 198. Transparent tube 198 defines an open upper end 183. Within tube 189, a check valve 184 controls liquid flow through an aperture 185 formed in tube 189. Within tube 189, a float 186 supports an indicator 187 which in turn supports an indicator 188. Indicator 188 is positioned within transparent tube 198.

A proportional reservoir 190 includes an open top 196 and a threaded neck 191. Threaded neck 191 secures proportional reservoir 190 to bracket 195 and valve 192. A bracket 205 is secured to pump cylinder 172 and further supports a valve 202 having a push button 203 and a discharge opening 204. A liquid concentrate reservoir 200 is supported upon bracket 205. Container 200 is in communication with valve 202 and supports a quantity of liquid 201.

In operation, a quantity of liquid such as water is initially deposited within the interior of reservoir 171 by removing pump mechanism 175 and pouring water downwardly through pump cylinder 172. Thereafter, pump mechanism 175 is replaced. With a quantity of water 180 received within reservoir 171, a liquid level 181 is established therein. In the absence of pressurization of reservoir 171, check valve 184 is open and the water level within tube 189 reaches level 181. The position of float 186 is established within tube 189 by the liquid level therein. Correspondingly, the position of indicator 188 within transparent tube 198 is established as float 186 is supported by the liquid within tube 189.

The user then actuates valve 202 using push button 203 to transfer a quantity of liquid concentrate 201 downwardly through discharge opening 204 through open top 196 of proportional reservoir 190. The transfer of liquid continues until the liquid level within reservoir 190 reaches level 197 in alignment with indicator 188. At this point, the operator releases push button 203 terminating downward liquid flow from container 200. The user then rotates vent and filler 177 to the open position and using push button 193 actuates valve 192 to transfer the liquid within proportional reservoir 190 through output 194 of valve 192 into reservoir 171 via vent and filler 177. Once the liquid within proportional reservoir 190 has been transferred to reservoir 171, vent and filler 177 is returned to its closed or sealed position.

At this point, pump sprayer system 170 has received the required liquid mix within reservoir 171. The user is then able to grasp handle 173 and utilizing pump rod 174 and pump mechanism 175 pressurize the interior of pump cylinder 172 and reservoir 171. As pressure is increased within reservoir 171, check valve 184 closes preventing open top 183 and tube 189 from releasing the pump sprayer pressure condition. At this point, the pump sprayer is configured and charged for use as the user then carries forward conventional spraying operations.

FIG. 8 sets forth a partially sectioned front view of pump sprayer 170. Pump sprayer 170 utilizes a proportional liquid-mixing system constructed in accordance with the present invention to provide proportional liquid mixing without the need for measurement of either liquid component and without the need for fully filling reservoir 171 within water prior to mixing process. The appropriate proportional volume of liquid concentrate is transferred to reservoir 171 by the above described apparatus.

More specifically, pump sprayer system 170 includes a reservoir 171 and an upwardly extending pump cylinder 172. A pump pressurizing mechanism 175 constructed in accordance with conventional fabrication techniques is secured within pump cylinder 172. A pump rod 174 is received within pump mechanism 175 and extends upwardly to a pump handle 173. Pump reservoir 171 further supports a hose attachment 176 which in turn is coupled to a fill tube 179 extending downwardly into reservoir 171. Hose attachment 176 is configured to receive a conventional sprayer hose and sprayer nozzle apparatus (not shown). Reservoir 171 further supports a vent valve and liquid filler 177. Valve 177 supports a downwardly extending tube 178.

A bracket 195 extends outwardly from pump cylinder 172 and further includes a valve 192 having a push button actuator 193 and an output 194. Output 194 is aligned with vent and filler 177. A tube 189 is formed within reservoir 171 and extends upwardly to a transparent tube 198. Transparent tube 198 defines an open upper end 183. Within tube 189, a check valve 184 controls liquid flow through an aperture 185 formed in tube 189. Within tube 189, a float 186 supports an indicator 187 which in turn supports an indicator 188. Indicator 188 is positioned within transparent tube 198.

A proportional reservoir 190 includes an open top 196 and a threaded neck 191. Threaded neck 191 secures proportional reservoir 190 to bracket 195 and valve 192. A bracket 205 is secured to pump cylinder 172 and further supports a valve 202 having a push button 203 and a discharge opening 204. A liquid concentrate reservoir 200 is supported upon bracket 205. Container 200 is in communication with valve 202 and supports a quantity of liquid 201.

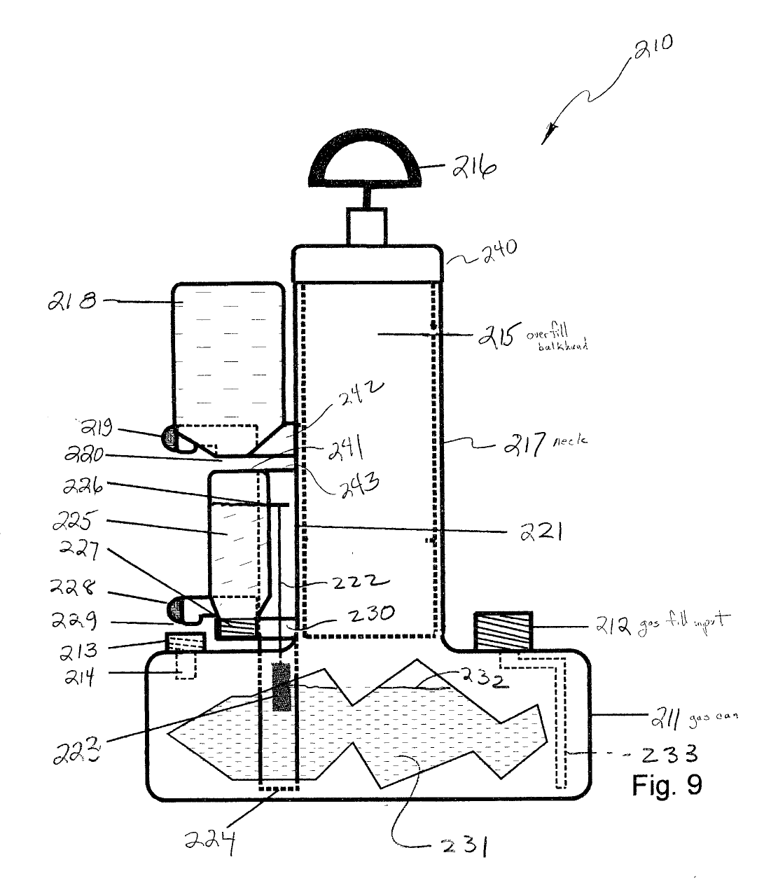

FIG. 9 sets forth a partially sectioned side elevation view of a still further alternate embodiment of the present invention proportional liquid-mixing system generally referenced by numeral 210. Mixing system 210 is somewhat similar in overall configuration to mixing system 170 set forth in FIGS. 7 and 8. System 210 is not a pressurizable spray apparatus but rather embodies the present invention proportional liquid-mixing system in an apparatus suitable for use in proportionally combining lubricating oil and gasoline for the above mentioned two cycle internal combustion engines. Thus, system 210 includes a gasoline container 211 having an upwardly extending neck 217 and a supporting handle 216. A bulkhead 215 is positioned within neck 217 to ensure that fuel does not pass upwardly through neck 217 should the container be shaken or dropped during use. A cap 240 removably secures bulkhead 215 within neck 217. A gasoline fill input 212 is coupled to a tube 233. Input 212 is a rotational valve which may be rotated between opened and closed positions. When rotated to its opened position, input 212 facilitates pouring gasoline into the interior of gasoline container 211. For purposes of illustration, a quantity of gasoline 231 establishing a liquid level 232 is shown within gasoline container 211. A rotatable valve 213 having a down spout 214 is rotatable between an open and closed position and is supported upon gasoline container 211. A bracket 230 is secured to neck 217 and supports a push button valve 228. Valve 228 includes a discharge opening 229 aligned with input 213. A proportional reservoir 225 includes a threaded neck 227 secured to bracket 30. Reservoir 225 is in communication with valve 228 such that opening valve 228 causes liquid within proportional reservoir 225 to flow downwardly through discharge opening 229, through input 213 and down spout 214 into the interior of gasoline container 211. Proportional reservoir 225 defines an open upper end 241.

A bracket 242 extends laterally from neck 217 and supports a lubricating oil reservoir 218 having a discharge valve 219 defining a discharge opening 220. Opening 220 is positioned above opening 241 of proportional reservoir 225.

System 210 further includes a tube 221 having an open lower end 224 within gasoline container 211 and preferably formed of a transparent material. Tube 224 further defines an open upper end 243. A float 223 having an upwardly extending indicator rod 222 supporting an indicator 226 is supported within tube 221 by liquid 231.

In operation, a quantity of gasoline 231 is deposited within gasoline container 211 establishing a liquid level 232. Open lower end 224 and open upper end 243 of tube 241 cause the liquid level within tube 221 to coincide with level 232. Accordingly, float 223 is supported upon the liquid within tube 221 positioning indicator 226 at a corresponding height. The user then dispenses the proportionate volume of lubricating oil from container 218 using valve 219 until the lubricating oil within proportional reservoir 225 coincides with indicator 226 as shown. Thereafter, the user simply actuates valve 228 discharging the quantity of lubricating oil within proportional reservoir 225 downwardly into gasoline container 211. As a result, the correct proportional volume of lubricating oil has been added to the gasoline within gasoline container 211. Thereafter, with valves 213 and 212 closed, the integrity of gasoline container 211 is reestablished and the user may transport the mixture for use. In the anticipated application of system 210, a conventional pour spout or similar apparatus is secured to gasoline fill input 212 and utilized in dispensing the mixture. In this process, tube 233 aids in smoothly flowing the dispensed fuel and lubricating oil mixture.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A proportional liquid-mixing system comprising:
a first liquid container receiving a first volume of first liquid and establishing a first liquid level therein;
a second liquid container receiving a second volume of a second liquid, said second liquid container defining a cross-sectional area which is related to a predetermined mixing ratio between said first and second liquids;
a level indicator responsive to said first liquid level for indicating the level of said second liquid within said second liquid container to establish a second volume related to said first volume of said first liquid in accordance with said mixing ration; and
means for combining said first and second volumes.

2. A proportional liquid-mixing system comprising:
a first liquid container having a first liquid volume defining a first liquid level;
a second liquid container for receiving a second liquid volume to define a second liquid level;
liquid level indication means having a level indicator proximate said second liquid container positioning said level indicator in response to said first liquid level;
means for filing said second liquid container with said second liquid to establish a second liquid level generally aligned with said position of said level indicator; and
means for transferring said second liquid to said first container.

3. The proportional liquid-mixing system set forth in claim 2 wherein said first and second containers define respective first and second cross-sectional areas related by a desired proportion.

4. The proportional liquid-mixing system set forth in claim 3 wherein said first and second liquid container cross-sectional areas are each generally constant within said first and second liquid containers.

5. The proportional liquid-mixing system set forth in claim 4 wherein said first liquid container is a mop bucket and said second liquid container is a proportional liquid concentrate reservoir.

6. The proportional liquid-mixing system set forth in claim 5 wherein said second liquid container is generally cylindrical.

7. The proportional liquid-mixing system set forth in claim 3 further including a third liquid container defining a third cross-sectional area different from said second cross-sectional area, said third liquid container being interchangeable with said second liquid container.

8. The proportional liquid-mixing system set forth in claim 4 wherein said first container is a pressurizable sprayer and said second liquid container is a proportional liquid concentrate reservoir.

9. The proportional liquid-mixing system set forth in claim 4 wherein said first liquid container is a gasoline container and said second liquid container is a lubricating oil proportional liquid reservoir.

10. The proportional liquid-mixing system set forth in claim 2 wherein said means for transferring said second liquid includes a valve actuatable to drain said second liquid into said first liquid container.

11. The proportional liquid-mixing system set forth in claim 2 wherein said means for transferring said second liquid includes a pivotable support for supporting said second liquid container in a vertical position and for pivoting said second liquid container to generally horizontal position pouring said second liquid volume into said first liquid container.

12. The proportional liquid-mixing system set forth in claim 1 wherein said system is well-mounted and includes means for coupling said first liquid container to a water supply.

13. The proportional liquid-mixing system set forth in claim 2 wherein said system is well-mounted and includes means for coupling said first liquid container to a water supply.
